(19) United States
(12) Patent Application Publication
(10) Pub. No.: US 2004/0225512 A1
(43) Pub. Date: Nov. 11, 2004

(54) System and method for vertical software solutions

(76) Inventors: David Armes, Phoenix, AZ (US); Gary Lacombe, Rye, NY (US); Javi Seera, Levittown, NY (US); Eric Worth, Bronx, NY (US)

Correspondence Address: SNELL & WILMER, ONE ARIZONA CENTER, 400 EAST VAN BUREN, PHOENIX, AZ, 850040001

(21) Appl. No.: 10/608,911

(22) Filed: Jun. 27, 2003

Related U.S. Application Data
(60) Provisional application No. 60/468,903, filed on May 8, 2003.

(51) Int. Cl. G06F 17/60

(52) U.S. Cl. 705/1

(57) ABSTRACT

A partnership program that facilitates delivery of a substantially complete vertical solutions to companies through a network of accessible software programs. The programs form a software stack to provide the solution and are accessed by a single contact point so that the companies need only communicate with one source and not necessarily multiple software programs and vendors. The programs in the software stack provide a variety of services such that together they provide a substantially complete solution to processing transactions for the companies.

### CROSS-REFERENCE TO RELATED APPLICATIONS

This application claims priority to, and the benefit of, U.S. Provisional Patent Application Ser. No. 60/468,903, filed on May 8, 2003, the entire contents of which is hereby incorporated by reference.

### FIELD OF THE INVENTION

The present invention generally relates to providing in effect a single source of software solutions for entities and, more particularly, relates to an apparatus and method for providing a vertical integrated software solution for processing transactions for entities.

### BACKGROUND OF THE INVENTION

A dramatic shift has recently occurred in the small to mid-sized business (SMB) information solutions market. Many customers want partners who understand their industry and can add business value as well as technical expertise. Many customers also want complete solutions from partners that can align their business processes to integrate with world-class technologies. These customers are demanding one solution, one contact and one relationship to manage their business processes. Moreover, vendors, facing intense competition, are interested in a national partner that adds value to their relationship by delivering a total solution. In the current market, top software vendors and partners deliver one solution, one contact and one relationship for one particular service, so SMB should be able to provide the same services. However, while many of these products or services may be available, the SMB would often need to negotiate with each product, but the SMB may not have the time or negotiating power to establish the optimum relationship.

### SUMMARY OF THE INVENTION

A method and apparatus consistent with the present invention provides a vertically integrated solution for processing transactions for entities such as small and medium size businesses. The method and apparatus receive a request for a transaction from an entity and determine which software programs can be used to process the transaction. The software programs are accessed to process the transaction and receive results of the processing, wherein the results are then provided to the requesting entity.

### BRIEF DESCRIPTION OF THE DRAWINGS

The accompanying drawings, wherein like reference numerals represent like elements, are incorporated in and constitute a part of this specification and, together with the description, explain the advantages and principles of the invention. In the drawings,

FIG. 1 is a diagram illustrating an exemplary system for providing an integrated vertical software solution;

FIG. 2 is a diagram of an exemplary software solution stack;

FIG. 3 is a diagram of an exemplary architecture for a distribution solution stack; and

FIG. 4 is a flow chart of an exemplary processing routine for an integrated vertical software solution.

### DETAILED DESCRIPTION

Overview

The present invention includes a partnership program that facilitates the delivery of substantially complete vertical solutions to SMB companies through, for example, a national network of software resellers and consultants. In an exemplary embodiment, the vendors certify the solution set and the host facilitates the development, certification process, selection of verticals, vendor management, national marketing, and/or the like. The system creates value for its members including partners, vendors, clients and business units.

The present invention may include products from major SMB software manufacturers (vendors), supported by a complete range of host management and technology consulting services. The software solution stack is suitably created for certain vertical markets. Best of breed products in the chosen industry are seamlessly integrated to deliver a total solution from a single source. The Solution Stack also includes a single source of support, maintenance and upgrades. The details of the Solution Stack are described herein for the distribution industry as one embodiment, but one skilled in the art may appreciate that the solution stack may be applicable to various industries and markets.

In one embodiment, a software product (“Solution Stack”) is created for the distribution industry that delivers comprehensive product functionality and a single source (or reduced sources) for support, maintenance and upgrades. The Solution Stack is comprised of, for example, products described below that, when integrated and customized, deliver a solution that is effectively greater than the sum of its parts. The Distribution Solution Stack may be delivered in three phases, for example, with each phase enhancing different aspects of the product, ultimately achieving the perception and behavior of a single product.

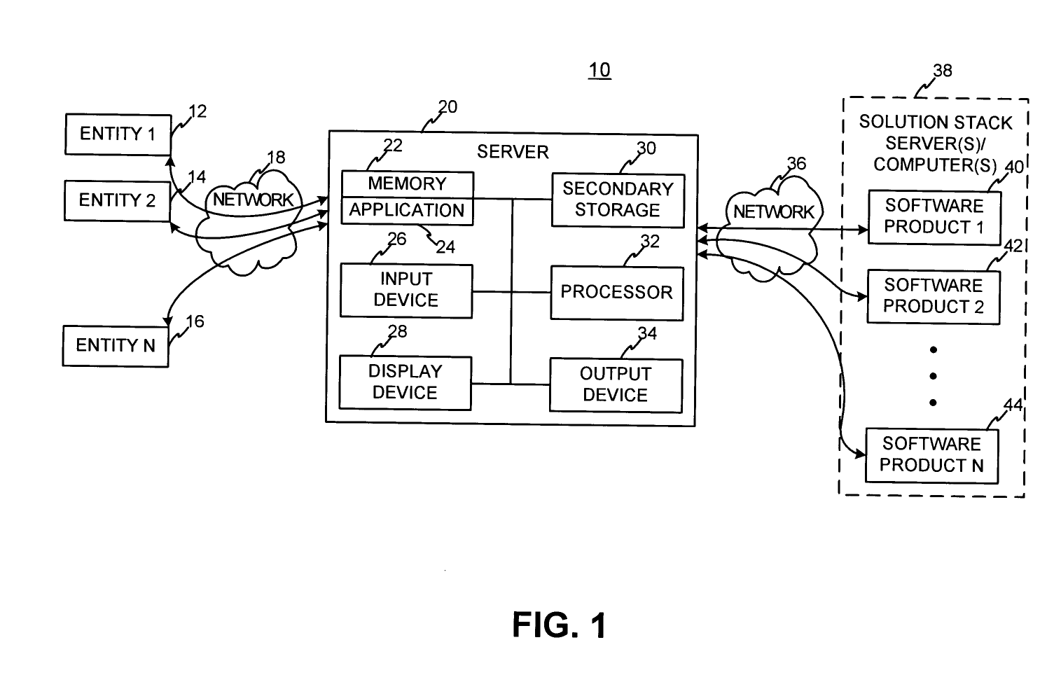

FIG. 1 is a diagram illustrating a system 10 for providing an example of this integrated vertical software solution. System 10 includes a server 20 that provides a single point of contact (or reduced points of contact) for multiple entities 12, 14, and 16 for multiple software products that process transactions from the entities. Each of the entities 12, 14, and 16 can contact and communicate with server 20 via a communications network 18. The communication can occur over any wireline or wireless network using any particular communications protocols or webpages. Entities 12, 14, and 16 typically represent a point of contact with a business or other entity, such as a small or medium size business. The point of contact can occur via a computer or network within the entity connected with network 18.

Server 20 can access a software solution stack 38 via a network 36, which can include any wireline or wireless communications network operating according to any particular communications protocols. Software solution stack 38 typically includes multiple computers or servers operating multiple software products 40, 42, and 44. Each of the software products 40, 42, and 44 typically provides a particular type of processing for a transaction. The software products can alternatively be run on a single machine, disparate machines accessed via a network, or even within server 20.

Server 20 is shown with the following typical components. Server 20 can include a connection with networks 18 and 36 such as the Internet or communications networks through any suitable network connection. Server 20 typically includes a memory 22, a secondary storage device 30, a processor 32, an input device 26 for entering information into server 20, a display device 28 for providing a visual display of information, and an output device 34 for outputting information such as in hard copy or audio form.

Memory 22 may include random access memory (RAM) or similar types of memory, and it may store one or more applications 24 for execution by processor 32. Applications 24 can include programming to call software products 40, 42, and 44 via application programming interfaces (APIs) or plug-ins, for example.

Secondary storage device 30 may include a hard disk drive, floppy disk drive, CD-ROM drive, or other types of non-volatile data storage. Processor 32 may execute applications or programs stored in memory 22 or secondary storage 30, or received from the Internet or other network 36. Although server 20 is depicted with various components, one skilled in the art will appreciate that the server can contain different components.

Server 20 can include local or remote databases for storing and retrieving information for processing transactions. Any databases discussed herein may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access or MSSQL by Microsoft Corporation (Redmond, Wash.), or any other database product. Database may be organized in any suitable manner, including as data tables or lookup tables. Association of certain data may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in each of the manufacturer and retailer data tables. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical electronic transaction system.

The system 10 may include a host server or other computing systems including a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor and a plurality of databases, said databases including client data, merchant data, financial institution data and/or like data that could be used in association with the present invention. As those skilled in the art may appreciate, user computer may typically include an operating system (e.g., Windows NT, 95/98/2000, Linux, Solaris, etc.) as well as various conventional support software and drivers typically associated with computers. User computer can be in a home or business environment with access to a network. In an exemplary embodiment, access is through the Internet through a commercially-available web-browser software package.

Communication between the parties to the transaction and the system of the present invention may be accomplished through any suitable communication means, such as, for example, a telephone network, Intranet, Internet, point of interaction device (point of sale device, personal digital assistant, cellular phone, kiosk, etc.), online communications, off-line communications, wireless communications, transponder communications and/or the like. One skilled in the art may also appreciate that, for security reasons, any databases, systems, or components of the present invention may include any combination of databases or components at a single location or at multiple locations, wherein each database or system includes any of various suitable security features, such as firewalls, access codes, encryption, de-encryption, compression, decompression, and/or the like.

The computers discussed herein may provide a suitable website or other Internet-based graphical user interface which is accessible by users. In one embodiment, the Internet Information Server, Microsoft Transaction Server, and Microsoft SQL Server, are used in conjunction with the Microsoft operating system, Microsoft NT web server software, a Microsoft SQL database system, and a Microsoft Commerce Server. Additionally, components such as Access or SQL Server, Oracle, Sybase, Informix MySQL, Intervase, etc., may be used to provide an ADO-compliant database management system.

It may be appreciated, that many applications of the present invention could be formulated. One skilled in the art may appreciate that the network may include any system for exchanging data or transacting business, such as the Internet, an intranet, an extranet, WAN, LAN, satellite communications, and/or the like. It is noted that the network may be implemented as other types of networks, such as an interactive television (ITV) network. The users may interact with the system via any input device such as a keyboard, mouse, kiosk, personal digital assistant, handheld computer (e.g., Palm Pilot®), cellular phone and/or the like. Similarly, the invention could be used in conjunction with any type of personal computer, network computer, workstation, minicomputer, mainframe, or the like running any operating system such as any version of Windows, Windows NT, Windows2000, Windows 98, Windows 95, MacOS, OS/2, BeOS, Linux, UNIX, Solaris or the like. Moreover, although the invention is frequently described herein as being implemented with TCP/IP communications protocols, it may be readily understood that the invention could also be implemented using IPX, Appletalk, IP-6, NetBIOS, OSI or any number of existing or future protocols. Moreover, the system contemplates the use, sale or distribution of any goods, services or information over any network having similar functionality described herein.

The computing units may be connected with each other via a data communication network. The network may be a public network and assumed to be insecure and open to eavesdroppers. In the illustrated implementation, the network may be embodied as the internet. In this context, the computers may or may not be connected to the internet at all times. For instance, the customer computer may employ a modem to occasionally connect to the internet, whereas the bank computing center might maintain a permanent connection to the internet. Specific information related to the protocols, standards, and application software utilized in connection with the Internet may not be discussed herein. For further information regarding such details, see, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997). All of these texts are hereby incorporated by reference.

The systems may be suitably coupled to network via data links. A variety of conventional communications media and protocols may be used for data links. Such as, for example, a connection to an Internet Service Provider (ISP) over the local loop as is typically used in connection with standard modem communication, cable modem, Dish networks, ISDN, Digital Subscriber Line (DSL), or various wireless communication methods. Merchant system might also reside within a local area network (LAN) which interfaces to network via a leased line (T1, D3, etc.). Such communication methods are well known in the art, and are covered in a variety of standard texts. See, e.g., GILBERT HELD, UNDERSTANDING DATA COMMUNICATIONS (1996), hereby incorporated by reference.

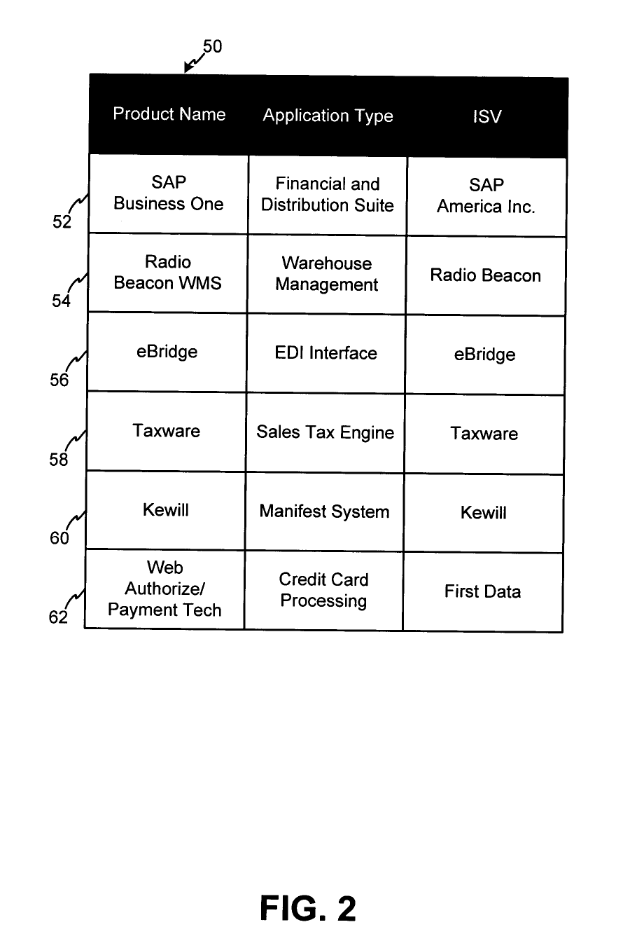

FIG. 2 is a diagram of a software stack 50 for the solution, as implemented for example in software solution stack 38 in system 10. Software stack 50 includes multiple software products from various independent software vendors (ISVs) providing various functions for processing transactions or business processes from the entities. The software products can be stored, for example, as executable programs accessed locally or remotely via a network. Together, these software products can provide a complete vertically integrated solution for the entities in this exemplary embodiment. In this example, software stack 50 includes a SAP Business One program 52 for providing financial and sales management capabilities; a Radio Beacon WMS program 54 providing warehouse management system services; an eBridge program 56 providing document integration and exchange of electronic data between business applications; a Taxware program 58 providing calculation of taxes and related services; a Kewill program 60 providing a variety of business-to-business services; and a Web Authorization program 62 providing credit card processing services.

Together, these programs can provide a substantially complete solution. In particular, Business One (SAP) includes various modules that provide rich functionality for order processing, purchase order processing, inventory management and/or financial applications. Radio Beacon WMS may be integrated to enhance the distribution functionality by providing a substantially complete warehouse management system. WMS may pick up the sales orders that are ready to be shipped and process them, including, for example, picking the items, packing and shipping. The cost and tracking information may be updated in Business One. The eBridge product may provide the EDI (Electronic Data Interchange) interface, which may allow the Solution Stack to receive purchase orders from customers, send invoices to customers and send Advance Ship Notices. Taxware is a full-featured sales tax management suite that also includes a sales tax calculation engine. SAP Business One may utilize this tax engine to calculate and present tax information. The credit card processing software may also be included. SAP Business One may use the credit card software to authorize the transaction at the time of placing the order and charge the card after the items have been shipped.

The programs shown in software stack 50 are known in the art and illustrate one example of programs providing various services for a complete software solution to processing transactions. Other implementations can include more or fewer programs, and possibly different commercial software programs for providing these services.

Distribution Solution Stack Architecture

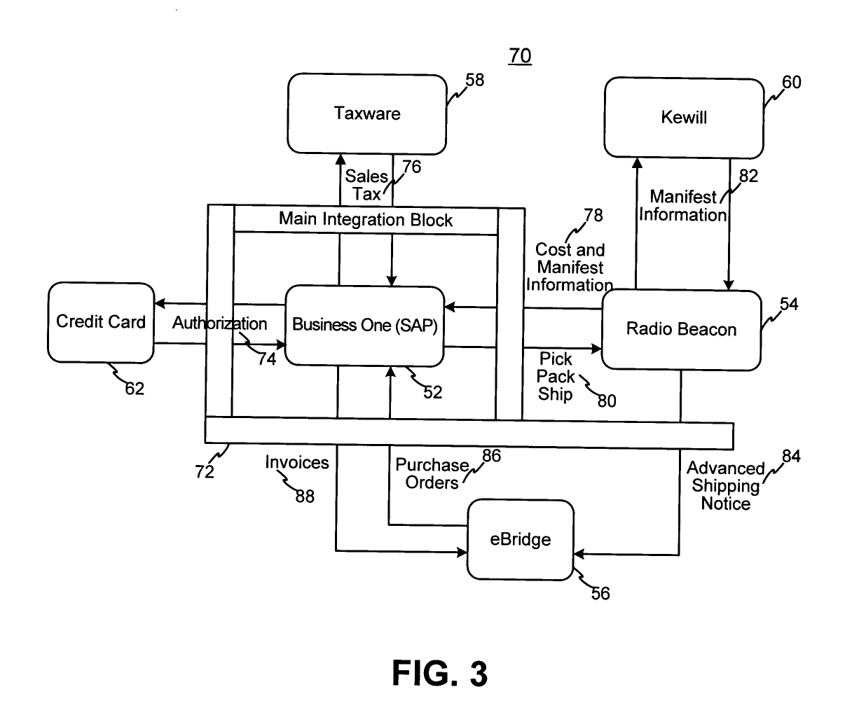

FIG. 3 is a diagram of an architecture overview 70 for a distribution software solution stack 38 and 50. Architecture 70 illustrates how the programs in software stack 50 communicate with each other. Each of the programs in software stack 50, in this exemplary embodiment, are commercially available software programs known in the art. Alternatively, other programs can be used, even custom programs if desired. Architecture 70 in this example provides the advantage of combining commercially available stand-alone programs so that custom software programs are not necessarily required.

In this example, the Business One (SAP) program 52 provides primary processing of transactions and can call or otherwise access the other programs to provide a complete solution to transaction processing. For example, it can use plug-ins or APIs to call or otherwise access the programs. The Business One (SAP) program 52 can access the other programs for the following services: Web Authorize program 62 for credit card processing and authorization services 74; Taxware program 58 for calculation of sales tax services 76; Radio Beacon WMS program 54 for cost and manifest information services 78 and pick pack ship services 80; and eBridge program 56 for purchase orders services 86 and invoices services 88.

These programs accessed by Business One (SAP) program 52 may also interact between each other to process transactions. In particular Radio Beacon WMS program 54 can interact with Kewill program 60 to provide manifest information services 82 and with eBridge program 56 to provide advance shipping notice services 84. Radio Beacon WMS program 54 can also use plug-ins or APIs to access those programs.

Business One (SAP) program 52 can use an integration block 72, for example, to access the other programs. The integration block 72 may act as a thin redirection layer, for example, that may provide robust integration yet it may keep the individual products safely decoupled. The integration layer may utilize the plug-in concept and each individual product may not call the other products' API directly. Alternatively, the system may call the API directly. In this manner, Business One (SAP) program 52 can access the various programs while still maintaining the programs separated from one another.

The product, as described above, may be delivered pre-installed and pre-configured on an IBM server, for example. Alternatively, one set of installation CDs and DVD may exist. Licensing and registration of the product may be handled by licensing and registering individual products before shipping the server to the client. Alternatively, the system may have a single licensing and registration management module that may allow the client to manage all modules from one application. The product may have single installation procedure that may install all applications and a licensing manager that may register all products from one screen.

Distribution Solution Stack Processing

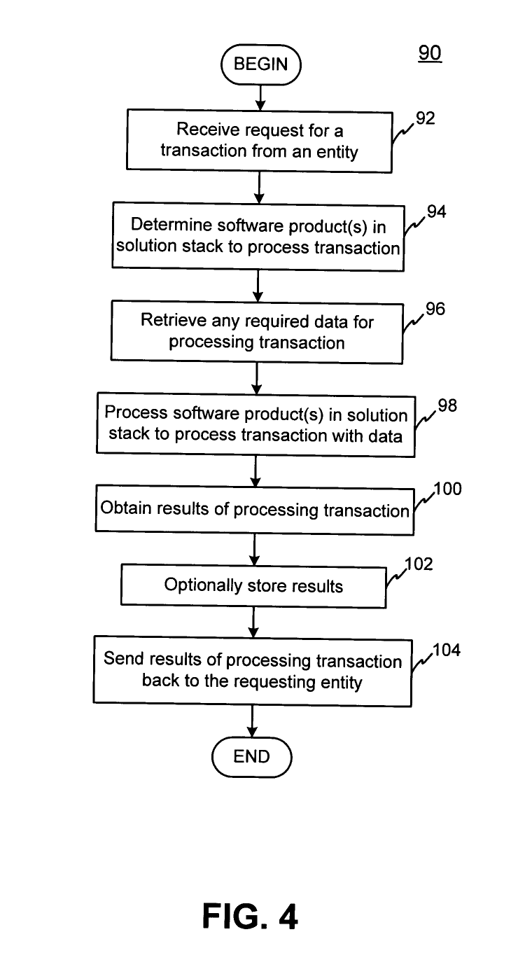

FIG. 4 is a flow chart of a method 90 for providing an integrated vertical software solution using architecture 70. Method 90 can be implemented, for example, by server 20 executing software modules such as Business One (SAP) program 52, which accesses the other programs in software stack 50, as represented in software solution stack 38, via network 36. Although the steps of method 90 are shown in a particular order, they can alternatively be executed in other orders and more steps can be added or steps removed, if necessary or desired.

The present invention may be described herein in terms of functional block components, screen shots, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by William Stalling, published by Prentice Hall; all of which are hereby incorporated by reference.

As may be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to screen shots, block diagrams and flowchart illustrations of methods, apparatus (e.g., systems), and computer program products according to various aspects of the invention. It may be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It may also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In method 90, server 20 receives a request for a transaction via network 18 from one of the entities 12, 14, and 16 (step 92). The request may be in any particular format for network transmission and sent according to any suitable protocol. The request may be received from a user or other person, for example, at the requesting entity. As used herein, the term “end user”, “consumer”, “customer”, “cardmember”, “business” or “merchant” may be used interchangeably with each other, and each shall mean any person, entity, machine, hardware, software or business. Although labeled as a “bank,” the bank may represent other types of card issuing institutions, such as credit card companies, card sponsoring companies, or third party issuers under contract with financial institutions. It is further noted that other participants may be involved in some phases of the transaction, such as an intermediary settlement institution, but these participants are not shown.

The request for a transaction can optionally include an account number. An “account number”, as used herein, may include any device, code, number, letter, symbol, digital certificate, smart chip, digital signal, analog signal, biometric or other identifier/indicia suitably configured to allow the consumer to interact or communicate with the system, such as, for example, authorization/access code, personal identification number (PIN), Internet code, other identification code, and/or the like which is optionally located on a rewards card, charge card, credit card, debit card, prepaid card, telephone card, smart card, magnetic stripe card, bar code card, transponder, radio frequency card and/or the like. The account number may be distributed and stored in any form of plastic, electronic, magnetic, radio frequency, wireless, audio and/or optical device capable of transmitting or downloading data from itself to a second device. A customer account number may be, for example, a sixteen-digit credit card number, although each credit provider has its own numbering system, such as the fifteen-digit numbering system used by American Express. Each company's credit card numbers comply with that company's standardized format such that the company using a sixteen-digit format may generally use four spaced sets of numbers, as represented by the number “0000 0000 0000 0000”. The first five to seven digits are reserved for processing purposes and identify the issuing bank, card type and etc. In this example, the last sixteenth digit is used as a sum check for the sixteen-digit number. The intermediary eight-to-ten digits are used to uniquely identify the customer.

Server 20, executing Business One (SAP) or other program 52 can determine which software products in software solution stack 38 are used to process this transaction (step 94). Based upon the requested service in the transaction, or other factors, program 52 can select those other programs providing processing for the corresponding service. For example, if the transaction requests computation of sales tax, program 52 can select Taxware program 58, which provides processing for tax-related services.

Business One (SAP) program 52, operating in server 20, can retrieve any data from local or remote databases as desired to process the transaction (step 96), and it can then access software products in software solution stack 38 via network 36 and integration block 72 to process the transaction using the relevant software products (step 98) and receive results of the processing (step 100). Based upon the requested service in the transaction, or other factors, program 52 can retrieve data required by the selected program. For example, if the transaction requests computation of sales tax, program 52 can retrieve tax rates for relevant geographic region.

Server 20 can optionally store results of the processing for the requesting entity (step 102). Business One (SAP) program 52, operating in server 20, can send results of processing the transaction back to the requesting entity via network 18 (step 104). The results can be in any particular format for network transmission according to any protocol. For example, if the transaction includes a request for computation of sales tax, program 52 can return to the requesting entity the calculated sales tax amounts.

Server 20 may return the results in a webpage, for example. The term “webpage” as it is used herein is not meant to limit the type of documents and applications that might be used to interact with the user. For example, a typical website might include, in addition to standard HTML documents, various forms, Java applets, Javascript, active server pages (ASP), common gateway interface scripts (CGI), extensible markup language (XML), dynamic HTML, cascading style sheets (CSS), helper applications, plug-ins, and the like. A server may include a webservice which receives a request from a browser which includes a URL (http://yahoo.com/stockquotes/ge) and an IP address (123.56.789). The webservice retrieves the appropriate webpages and sends the webpages to the IP address.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

The detailed description of exemplary embodiments of the invention herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

1. A vertically integrated method for facilitating the processing of transactions for entities, comprising:
receiving a request for a transaction from an entity;
determining software programs, among a plurality of software programs providing processing for different services, for processing the transaction;
accessing the software programs to process the transaction; receiving results of the processing; and
providing the results to the entity.

2. The method of claim 1 wherein the receiving step includes receiving the request via a network.

3. The method of claim 1 wherein the accessing step includes accessing a solution stack having a plurality of software programs providing services to process the transaction.

4. The method of claim 1 wherein the accessing step includes using an integration block to access the software programs and maintain the software programs decoupled.

5. The method of claim 1 wherein the accessing step includes using the software programs providing the following services: credit card processing, calculation of taxes, warehouse management, shipping, and invoicing.

6. The method of claim 1, further including providing to the entities a single access point for processing of transactions using the software programs.

7. An apparatus for providing a vertically integrated solution for processing transactions for entities, comprising:
a module configured to receive a request for a transaction from an entity;
a module configured to determine software programs, among a plurality of software programs providing processing for different services, for processing the transaction;
a module configured to access the software programs to process the transaction and to receive results of the processing; and
a module configured to provide the results to the entity.

8. A method for providing a single source for facilitating the processing of transactions for business entities using a plurality of software programs, comprising:
providing to the entities a single communication point;
receiving via the single communication point requests for transactions from the entities;
calling a plurality of software programs in a solution stack to process the transactions;
receiving results of the processing; and
returning to the entities via the single communication point the results of the processing.

9. The method of claim 8, further comprising decoupling the plurality of software programs using an integration block.

10. The method of claim 8 wherein the calling step includes using the plurality of software programs providing the following services: credit card processing, calculation of taxes, warehouse management, shipping, and invoicing.

11. The method of claim 8 wherein the receiving step includes receiving the requests via a network.

12. The method of claim 11 wherein the returning step includes sending the results of the processing to the entities via the network.

13. The method of claim 8 wherein the calling step includes using software plug-ins to access the plurality of software programs.

14. The method of claim 8 wherein the calling step includes using one of the plurality of software programs that calls the others of the plurality of software programs for processing the transactions.
